(19) United States
(12) Patent Application Publication
(10) Pub. No.: US 2025/0181909 A1
(43) Pub. Date: Jun. 5, 2025

(54) SYNTHETIC DATASET REGENERATION FOR AI SYSTEMS AND APPLICATIONS

(71) Applicant: NVIDIA Corporation, Santa Clara, CA (US)

(72) Inventors: Matthew Trepte, San Francisco, CA (US); Jack Yusong Zhang, San Jose, CA (US); Gordon Grigor, San Francisco, CA (US)

(21) Appl. No.: 18/524,894

(22) Filed: Nov. 30, 2023

(51) Int. Cl. G06N 3/08

(52) U.S. Cl. CPC G06N 3/08

(57) ABSTRACT

In various examples, synthetic dataset regeneration for AI systems and applications is described herein. For instance, systems and methods described herein may use a simulator to generate a synthetic dataset along with data (referred to, in some examples, as “log data”) representing information associated with the generation of the synthetic dataset by the simulator. For instance, the log data may represent at least parameters used to generate synthetic dataset, values for the parameters, assets associated with the parameters, and/or values representing results associated with the synthetic dataset. The systems and methods may then use the log data to recreate, modify, and/or enhance the synthetic dataset. For example, the synthetic dataset may be recreated by providing at least the log data as input to the simulator such that the simulator regenerates the dataset using the same parameters, values, and/or assets.

### BACKGROUND

Increasingly, many common processing tasks, such as image classification, object segmentation, localization, depth approximation, caption generated, and/or the like, are implemented using neural networks (or other types of machine learning models). In order to increase the performance of these neural networks, datasets may be used for training, where the performance of the neural networks may be based on the quality of the datasets. The quality of a dataset may be measured according to a composite evaluation of the dataset according to various properties, such as scale, coverage, diversity, accuracy, distribution, and target-domain alignment. Naturally, high quality datasets may require a large amount of data to achieve at least some of these properties. As such, the use of synthetic data has increasingly become more common in the creation of high quality datasets, since simulators are able produce large amounts of data with high variability, at lower costs, and with better ground truth as compared to real data.

For instance, to generate a dataset for training a neural network, a simulator may receive inputs, such as parameters for the simulations, values for the parameters, assets associated with the parameters, and/or the like. The simulator may then sample the parameters, such as by randomly selecting the values that are used to generate samples (e.g., scenes) associated with the dataset. Because of this, since each of the samples may be generated using random values for the parameters, the samples generated by the simulator for the dataset may be unique. As such, while users may later be able to make copies of the dataset, such as copies of scenes representing objects, the users may be unable to regenerate the dataset using the simulator since different values may be sampled. This may cause problems in various situations, such as when the users want to modify the dataset, enhance the dataset, fix errors with the dataset, and/or the like.

### SUMMARY

Embodiments of the present disclosure relate to synthetic dataset regeneration for AI systems and applications. For instance, systems and methods described herein may use a simulator to generate a dataset along with data (referred to, in some examples, as “log data”) representing information associated with the generation of the dataset by the simulator. For instance, the log data may represent at least parameters used to generate a dataset, values for the parameters, assets associated with the parameters, and/or values representing results associated with the dataset (e.g., stochastic values derived from the simulation processes). The systems and methods may then use the log data to recreate, modify, and/or enhance the dataset. For example, the dataset may be recreated by providing at least the log data as input to the simulator such that the simulator regenerates the dataset using the same parameters, values, and/or assets. If the dataset is to be modified and/or enhanced, at least a portion of the information represented by the log data may be updated and/or data representing new parameters and/or values may also be input into the simulator.

In contrast to conventional systems, such as those described above, the current systems, in some embodiments, are able to regenerate a dataset using the log data generated during the initial processing performed by the simulator when generating the dataset. For instance, and as described above, conventional systems may only be able to generate copies of the final dataset, but the conventional systems may not be able to regenerate the dataset using a simulator. For similar reasons, and in contrast to the conventional systems, the current systems, in some embodiments, are further able to enhance a dataset (increasing the randomization, adding assets, etc.), modify the dataset, generate new samples (e.g., scenes) for the dataset, fix the dataset (e.g., if the simulator is affected by bugs), and/or provide additional improvements. As will be described in more detail herein, the current systems are able to provide such improvements based on allowing users to modify the dataset that is used to regenerate the dataset and/or allowing users to provide new parameters and/or values for the new parameters when regenerating the dataset.

### BRIEF DESCRIPTION OF THE DRAWINGS

The present systems and methods for synthetic dataset regeneration for AI systems and applications are described in detail below with reference to the attached drawing figures, wherein:

FIG. 1A illustrates an example data flow diagram for a process of generating log data associated with a simulation, where the log data may later be used to regenerate a dataset associated with the simulation, in accordance with some embodiments of the present disclosure;

FIG. 1B illustrates an example data flow diagram for a process of regenerating a dataset using log data associated with a previous simulation, in accordance with some embodiments of the present disclosure;

FIG. 1C illustrates an example data flow diagram for a first process of regenerating a dataset using one or more modifications and/or enhancements, in accordance with some embodiments of the present disclosure;

FIG. 1D illustrates an example data flow diagram for a second process of regenerating a dataset using one or more modifications and/or enhancements, in accordance with some embodiments of the present disclosure;

FIGS. 2A-2B illustrate examples of a simulator generating datasets, in accordance with some embodiments of the present disclosure;

FIGS. 3A-3B illustrate examples of generation logs associated with simulations, in accordance with some embodiments of the present disclosure;

FIG. 4 illustrates an example of a dataset that is regenerated to be substantially similar to a previously generated dataset, in accordance with some embodiments of the present disclosure;

FIG. 5 illustrates an example of updating a generation log associated with a simulation, in accordance with some embodiments of the present disclosure;

FIG. 6 illustrates an example of a modified dataset that is regenerated to be similar to a previously generated dataset based at least on using modified log data, in accordance with some embodiments of the present disclosure;

FIG. 7 illustrates an example of a modified dataset that is regenerated to be similar to a previously generated dataset based at least on using one or more new parameter files, in accordance with some embodiments of the present disclosure;

FIG. 8 is a flow diagram showing a method for generating log data that is later used for regenerating a dataset associated with a simulation, in accordance with some embodiments of the present disclosure;

FIG. 9 is a flow diagram showing a method for regenerating a dataset using log data associated with a previous simulation, in accordance with some embodiments of the present disclosure;

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure;

FIG. 10D is a system diagram for communication between cloud-based server(s) and the example autonomous vehicle of FIG. 10A, in accordance with some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

Systems and methods are disclosed related to synthetic dataset regeneration for AI systems and applications. For instance, a system(s) may receive input data that is used by a simulator to generate a synthetic dataset. As described herein, the input data may include at least parameter data representing one or more parameters files, asset list data representing one or more asset lists, and/or asset data representing one or more assets. In some examples, a parameter file may include key value pairs, such as pairs that associate various parameters with various values. As described herein, at least a portion of the values may include set values and/or at least a portion of the values may include random values (e.g., distributions, etc.). Additionally, the parameters may include object parameters (e.g., types, counts, textures, models, poses, colors, etc.), camera parameters (e.g., configurations, lens parameters, resolution parameters, etc.), lighting parameters, scenario parameters, output parameters (e.g., dataset name, dataset size, sequence timesteps, dataset type, etc.), and/or any other type of parameter associated with performing simulations.

In some examples, a parameter file may refer to an asset list that stores references to assets, such as in text. For instance, the asset list may include a grouping of assets, such as objects, camera coordinates, textures, materials, and/or so forth. For example, an asset list associated with vehicles may include a list of vehicles (also referred to as elements) where, during sampling, a vehicle (e.g., an element) from the list may be selected. The selected assets may then be retrieved from the asset data. In some examples, the asset data may be stored on one or more servers that are accessible to the simulator. In some examples, the assets represented by the asset data may further be associated with version numbers. For example, an asset may initially be associated with a first version number (e.g., 1), a first update to the asset may be associated with a second version number (e.g., 2), a second update to the asset may be associated with a third version number (e.g., 3), and/or so forth.

As described in more detail herein, during the simulation, the parameters may be sampled in order to determine values associated with the parameters. In some examples, the parameters are sampled in an order during the simulation. For example, a first parameter may be sampled to determine a first value associated with the first parameter, a second parameter may then be sampled to determine a second value associated with the second parameter, a third parameter may then be sampled to determine a third value associated with the third parameter, and/or so forth. Additionally, asset data associated with the needed assets may be retrieved and used to generate the dataset, where the asset data is retrieved based at least on the sampling of the parameters and/or the values. The simulator may then generate the dataset using the parameters, the values for the parameters, and/or the assets. As described herein, in some examples, the dataset may represent simulated scenes (e.g., images), simulated videos, simulated text, simulated systems, and/or any other type of simulated data.

As described herein, in order to regenerate the dataset, the system(s) may further generate log data representing one or more logs that include information associated with the simulation(s). For example, a log may represent at least the parameters used by the simulator, the values associated with the parameters, the assets retrieved, final values resulting from the stochastic processes of the simulator (e.g., (e.g., stochastic values derived from the simulation processes, such as values representing the final poses of objects), and/or any other information. In some examples, the parameters are written to the log in a same order as the parameters that were used (e.g., sampled) by the simulator when generating the dataset. For example, and using the example above, the first parameter sampled and/or the first value associated with the first parameter may be written, followed by the second parameter sampled and/or the second value associated with the second parameter, followed by the third parameter sampled and/or the third value associated with the third parameter, and/or so forth.

The system(s) may then use at least the log data to regenerate the dataset (and/or a portion of the dataset, such as a specific scene) by again performing the simulation(s) using the simulator. For example, the system(s) may input the log data (and/or the portion of the log data that is associated with the portion of the dataset) into the simulator. The simulator may then process the log data in order to regenerate the dataset using the same parameters, values, and/or assets as were used in the original simulation to generate the original dataset. In some examples, since the parameters may be written to the log using the same order as the parameters that were used by the simulator during the original simulation(s), the simulator may again sample the parameters in the same order during the new simulation(s), which may increase the accuracy of the regenerated dataset.

In some examples, the system(s) may further regenerate the dataset with modifications and/or enhancements. As described herein, a modification may include changing a parameter associated with a dataset, such as a camera configuration, an object pose (e.g., location, orientation, etc.), an object type, and/or so forth. Additionally, an enhancement may include the addition of a new asset, such as a new object, texture, material, and/or so forth. In some examples, the system(s) may regenerate the dataset with the modifications and/or enhancements based at least on a user and/or device updating one or more parameters, one or more values, and/or one or more assets represented by the log data. In such examples, the system(s) may then input the updated log data into the simulator to regenerate the modified and/or enhanced dataset. In some examples, the system(s) may regenerate the dataset with the modifications and/or enhancements based at least on generating new parameter data (e.g., one or more new parameter files) representing one or more new parameters and/or one or more values associated with the new parameter(s). In such examples, the system(s) may then input the log data and the new parameter data into the simulator to regenerate the modified and/or enhanced dataset.

In some examples, when regenerating a dataset (and/or a modified and/or enhanced dataset), the system(s) may again generate log data representing one or more logs that include information associated with the simulation(s). For example, a log may represent at least the parameters used by the simulator, the values associated with the parameters, the assets retrieved, final values resulting from the stochastic processes of the simulator (e.g., values representing the final poses of objects), and/or any other information associated with the regeneration. As such, the system(s) may continue to use the log data to again regenerate, modify, and/or enhance the dataset.

As described herein, performing these processes may provide for multiple improvements over conventional systems. For a first example, the processes described herein may allow for enhancing and/or modifying existing synthetic datasets, such as by adding new assets (e.g., objects) to an existing scene, changing textures of objects, modifying camera configurations, modifying lighting, and/or the like. Additionally, and for similar reasons, new annotations and/or ground truths may be added to existing synthetic datasets, which may allow for the training and/or evaluation of different tasks. For instance, the processes may allow for adding finer semantic layers to a segmentation mask for objects and/or allow for users to add new features that may produce new annotations associated with the synthetic dataset.

The processes described herein may also allow for the regeneration of synthetic datasets that were streamed directly to a network without being written to disk (e.g., the synthetic datasets cannot be copied). For instance, regenerating synthetic datasets that were streamed directly to the network may allow for training content to be reexamined post-generation if desired using the regenerated synthetic datasets.

The processes described herein may also allow for the regeneration of synthetic datasets that were affected by bugs, such as in the simulator, that cause problems with the synthetic datasets. For instance, regenerating synthetic datasets that were affected by unintended phenomena (e.g., anomalies, bugs, artifacts, or other issues) may allow for fixing of desirable properties associated with the synthetic datasets that are affected.

The processes described herein may also allow for a verification step to test an integrity of software builds and hardware configurations. For example, a regenerated synthetic dataset may be compared to a previously generated synthetic dataset to check for problems that may be occurring with respect to the software builds and/or the hardware configurations. For instance, if the regenerated synthetic dataset does not substantially match with the previously generated synthetic dataset (e.g., one or more objects are depicted differently, such as by using a different color), then this may indicate that there is a problem with the software builds and/or the hardware configuration.

As described herein, different files may be used for different aspects of the invention, such as for parameter files, asset lists, asset files, generation logs, and/or so forth. In some examples, any type of file may be used such as, but not limited to, a YAML file, a Universal Scene Description (USD) file, a Portable Network Graphic (PNG) file, a Printer Font Metrics (PMF) file, an image file, a text file, a Graphics Interchange Format (GIF) file, a Portable Networks Graphics (PNG) file, a Portable Document Format (PDF) file, and/or any other type of file format.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implemented at least partially using cloud computing resources, and/or other types of systems.

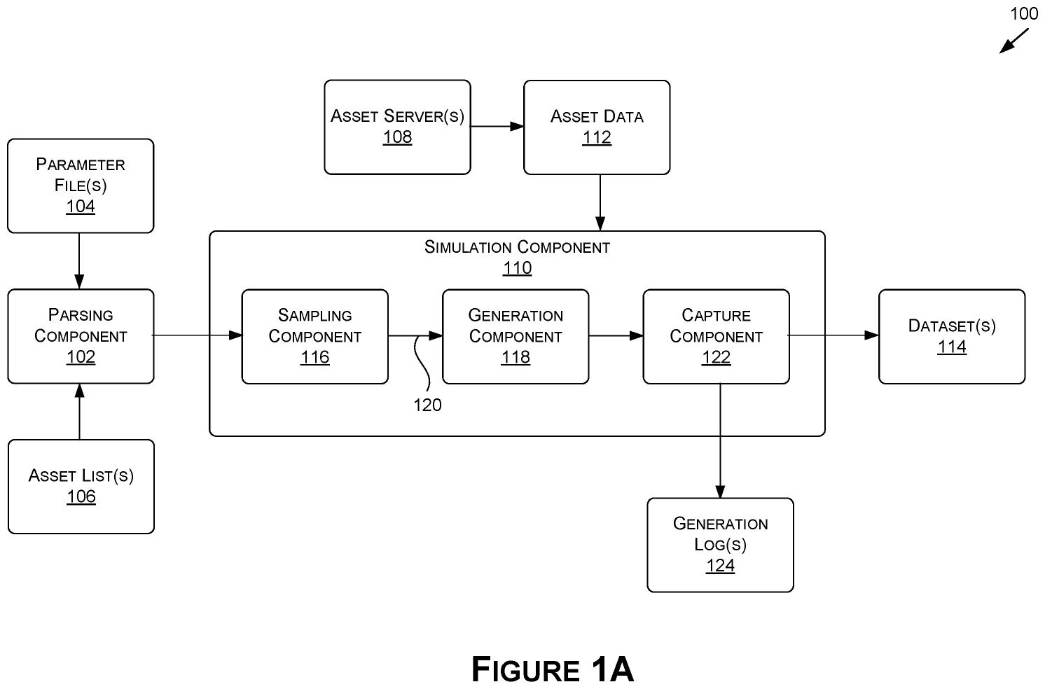

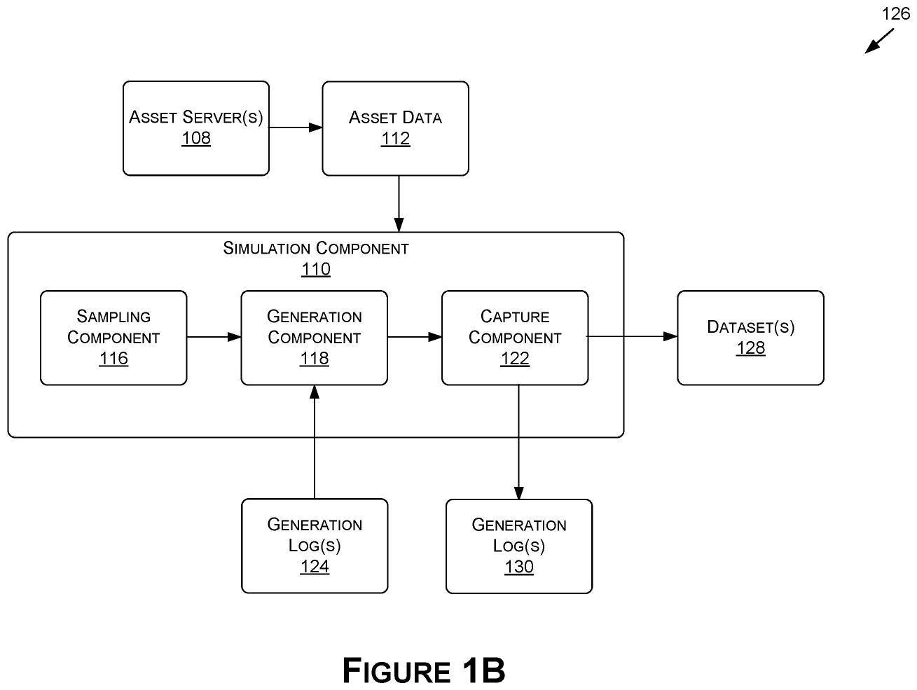

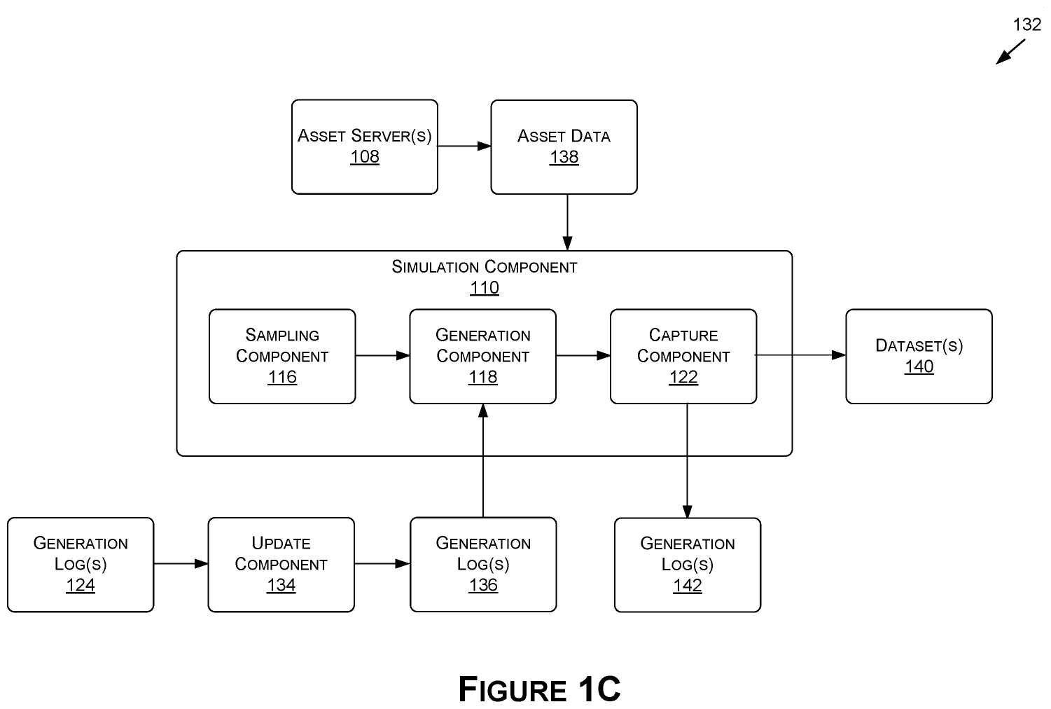

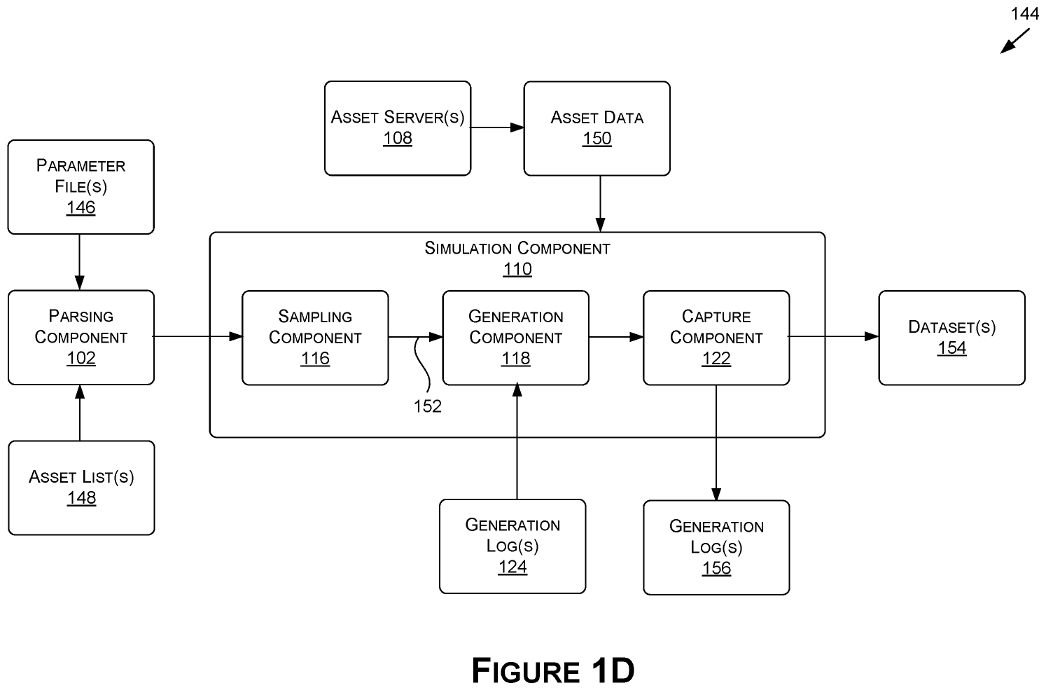

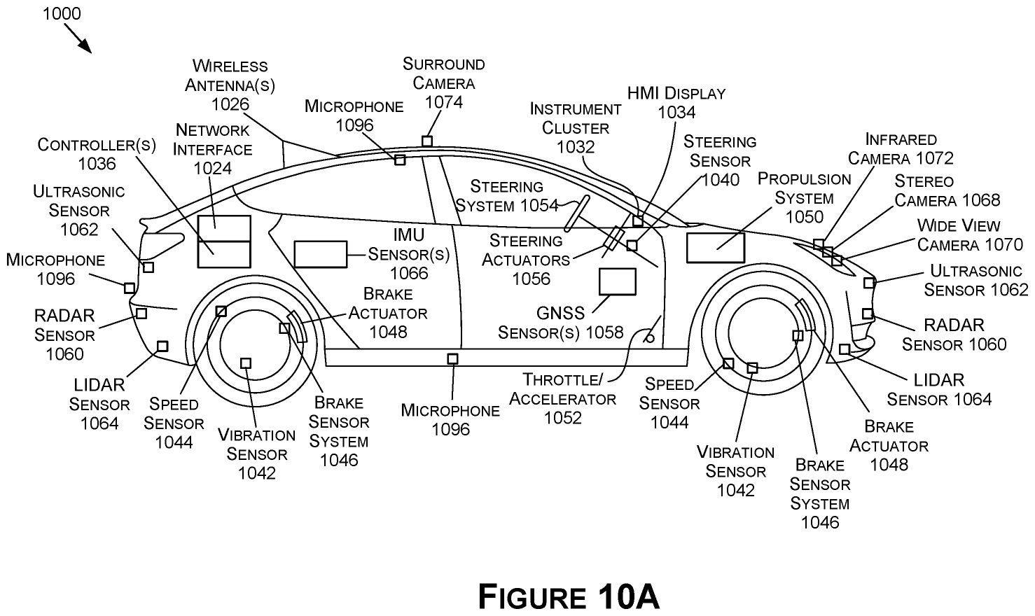

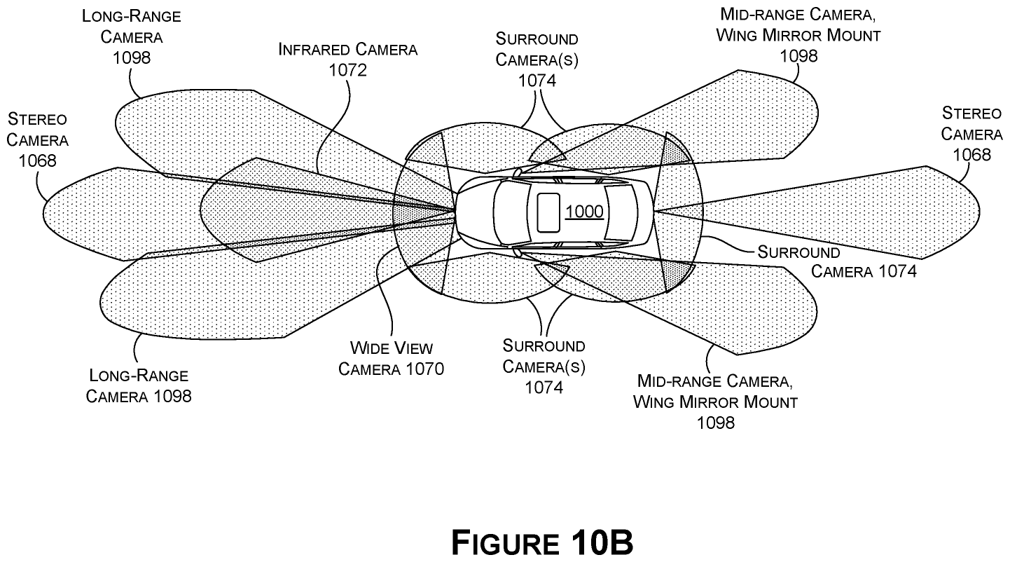

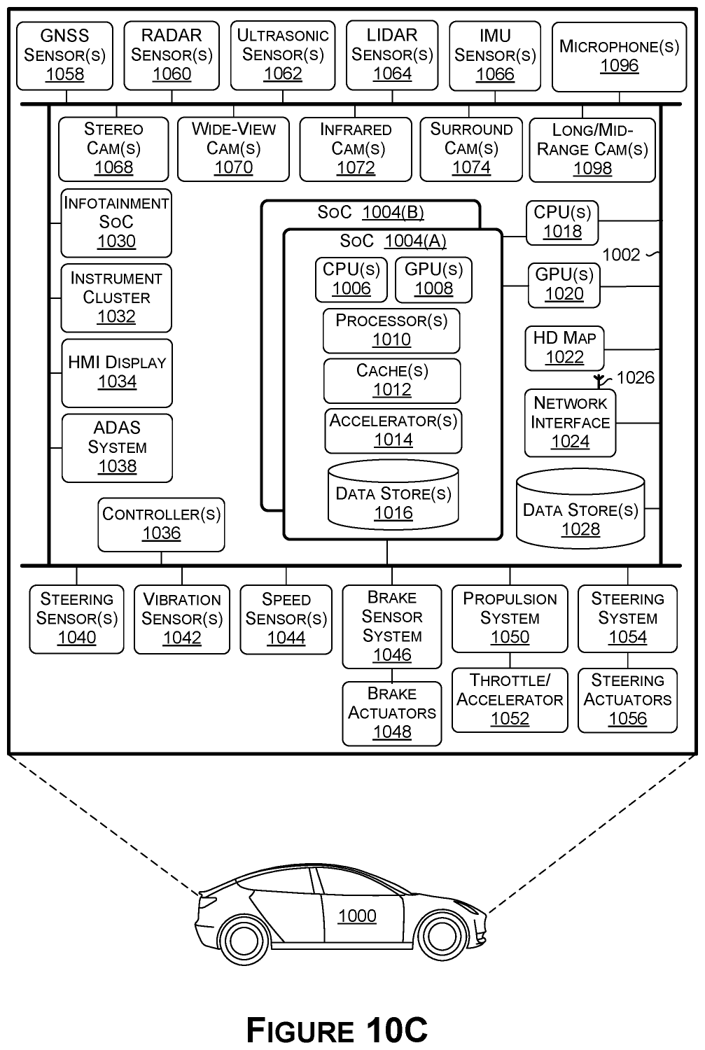

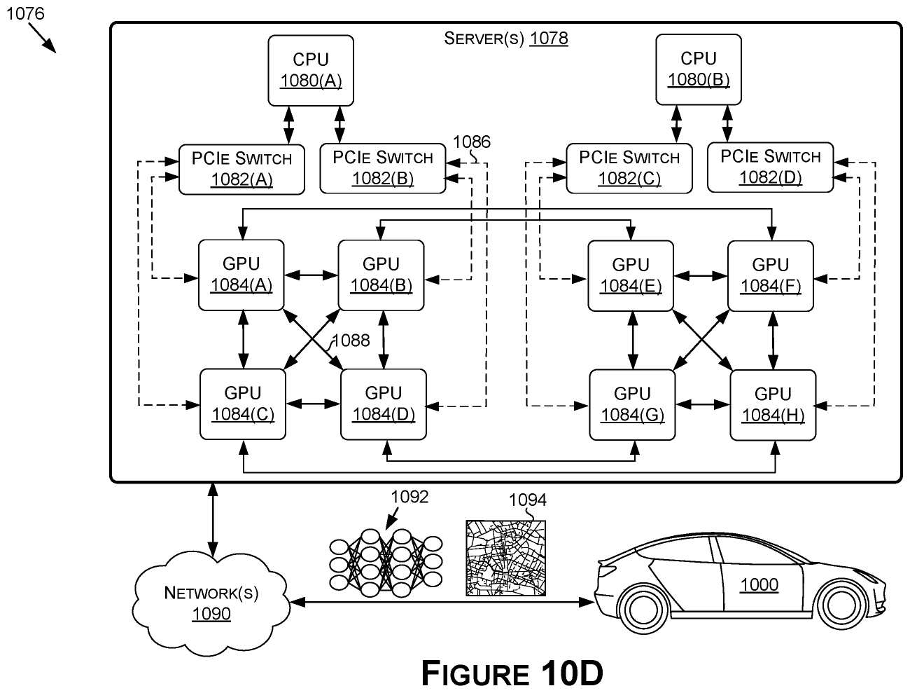

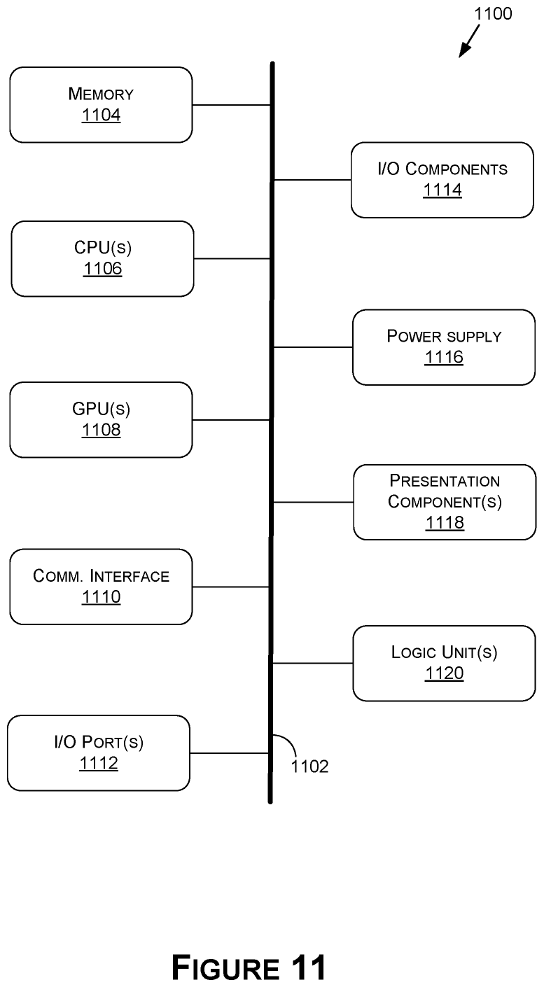

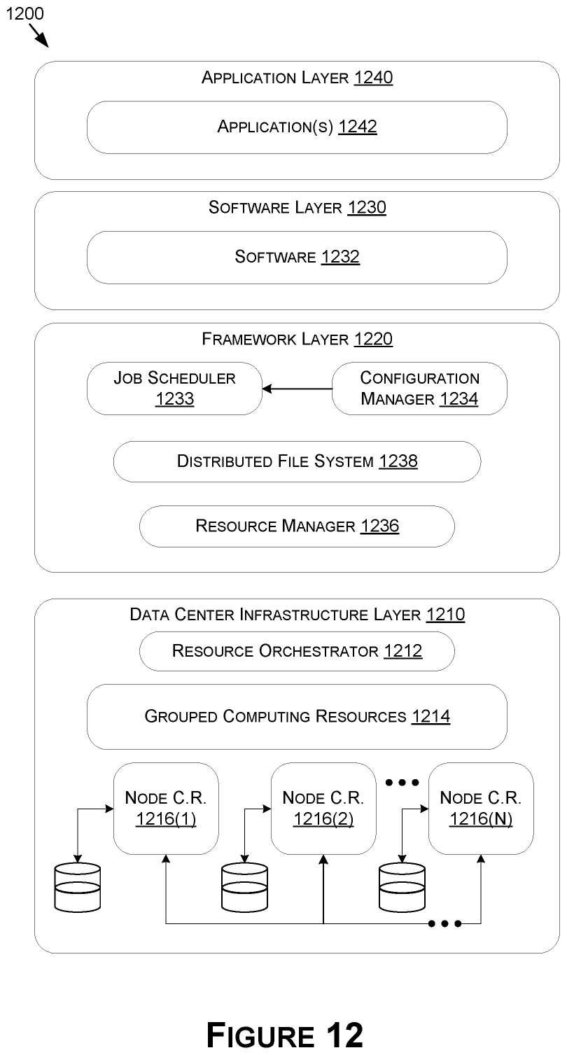

With reference to FIG. 1, FIG. 1A illustrates an example data flow diagram for a process 100 of generating log data associated with a simulation, where the log data may later be used to regenerate a dataset associated with the simulation, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1000 of FIGS. 10A-10D, example computing device 1100 of FIG. 11, and/or example data center 1200 of FIG. 12.

The process 100 may include a parsing component 102 receiving one or more parameter files 104 and/or one or more asset lists 106. As described herein, a parameter file 104 may include key value pairs, such as pairs that associate various parameters with various values. In some examples, a value may include a set value (e.g., a primitive) associated with a deterministic parameter or a random value (e.g., a distribution) associated with a stochastic parameter. Additionally, a set value may include a number, a string, a tuple, and/or the like, while a random value may include a normal, a range, a choice, a walk, and/or the like. In some examples, parameters may include object parameters (e.g., types, counts, textures, models, poses, colors, etc.), camera parameters (e.g., configurations, lens parameters, resolution parameters, etc.), lighting parameters, scenario parameters, output parameters (e.g., dataset name, dataset size, sequence timesteps, dataset type, etc.), and/or any other type of parameter associated with simulations. In some examples, the parameters may be grouped into parameter groups. For example, a first group may include random objects that are chaotic, a second group may include objects that are realistic, a third group may include a type of object (e.g., people, vehicles, etc.), and/or so forth.

An asset list 106 may include a list of assets, such as in the form of a text file, where the parameter file(s) 104 refers to the asset list 106. As described herein, an asset may include, but is not limited to, an object, texture, a material, camera coordinates, and/or any other type of asset. For example, an asset list 106 may include a list of objects that may be included within a simulation, where the asset list 106 includes text paths to files on one or more asset servers 108 that are associated with the object assets. As another example, an asset list 106 may include a list of a specific type of object, such as people, that may be included within a simulation, where the asset list 106 again includes text paths to files on the asset server(s) 108 that are associated with the people assets. As shown, the process 100 may include the parsing component 102 at least combining the parameter file(s) 104 with the asset list(s) 106 and then sending the parameter file(s) and the asset list(s) 106 to a simulation component 110 as input.

The process 100 may include the asset server(s) 108 inputting asset data 112 into the simulation component 110 as input. For instance, the asset server(s) 108 may store files (e.g., USD files) that represent assets that may be used in simulations. As described herein, an asset may include a physically-accurate two-dimensional (2D) and/or three-dimensional (3D) object that encompasses accurate physical properties, behaviors, and connected data stream to represent the real world in simulated digital worlds. In some examples, an asset may be associated with a version number. For example, the asset may initially be associated with an initial version number, such as version one. After the asset is then updated, the updated asset may be associated with a second version number, such as version two. This may continue to repeat as the asset continues to be updated, where these version numbers may be important for the regeneration of datasets, as described in more detail herein. The asset data 112 may thus represent one or more assets that are used by the simulation component 110 as input.

As described herein, the simulation component 110 may include one or more simulators that are configured to receive inputs, perform one or more simulations using the inputs (e.g., perform generation), and then output one or more datasets 114 associated with the simulation(s). In some examples, the dataset(s) 114 may include simulated scenes (e.g., images), simulated videos, simulated text, simulated systems, and/or any other type of simulated data. For a first example, if the simulation component 110 is configured to generate simulations associated with an object dropping, then a dataset 114 may include one or more scenes depicting the object from at least a time that the object starts to fall to a time that the object finally rests. For a second example, if the simulation component 110 is configured to generate simulations associated with a vehicle navigating within an environment, then a dataset 114 may include one or more scenes depicting objects (e.g., vehicles, pedestrians, traffic signals, etc.) located within the environment for which the vehicle is navigating over a period of time.

In some examples, the simulation component 110 may be configured to generate a number of simulations. As described herein, the number of simulations may include, but is not limited to, one simulation, five simulations, ten simulations, fifty simulations, one hundred simulations, one thousand simulations, ten thousand simulations, and/or any other number of simulations. For example, and again if the simulation component 110 is configured to generate simulations associated with an object falling, then the simulation component 110 may perform a number of simulations using the inputs to generate different scenes depicting the object falling until resting at various locations within an environment. In such an example, the locations may differ from one another based at least on each simulation including different parameters and/or different values for parameters.

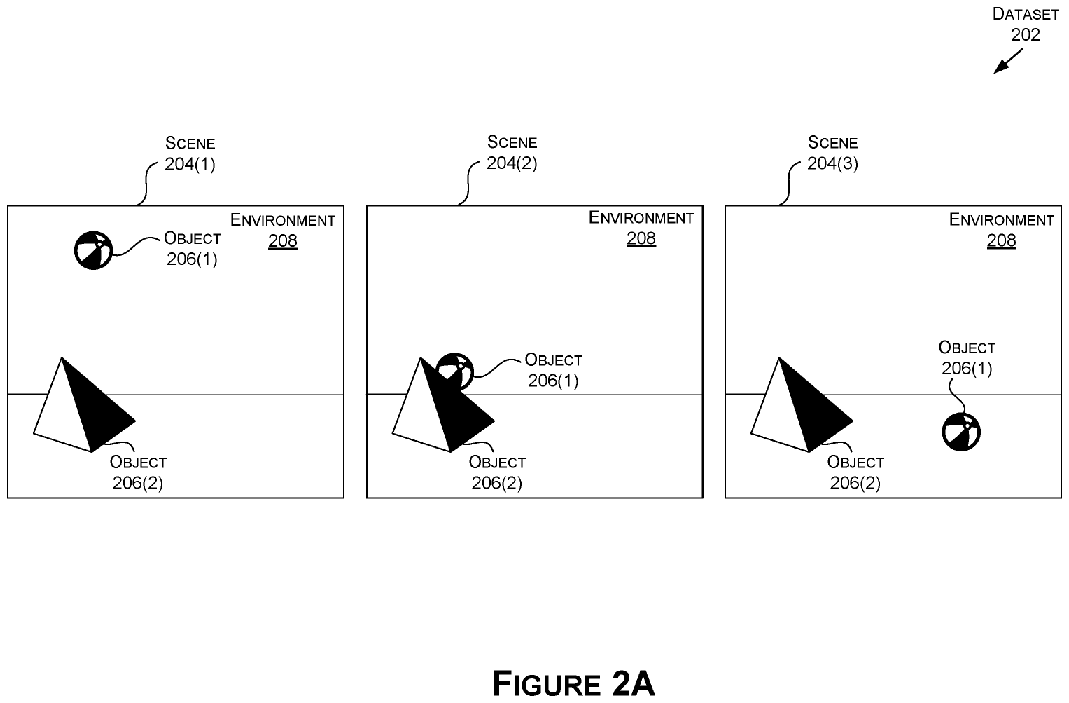

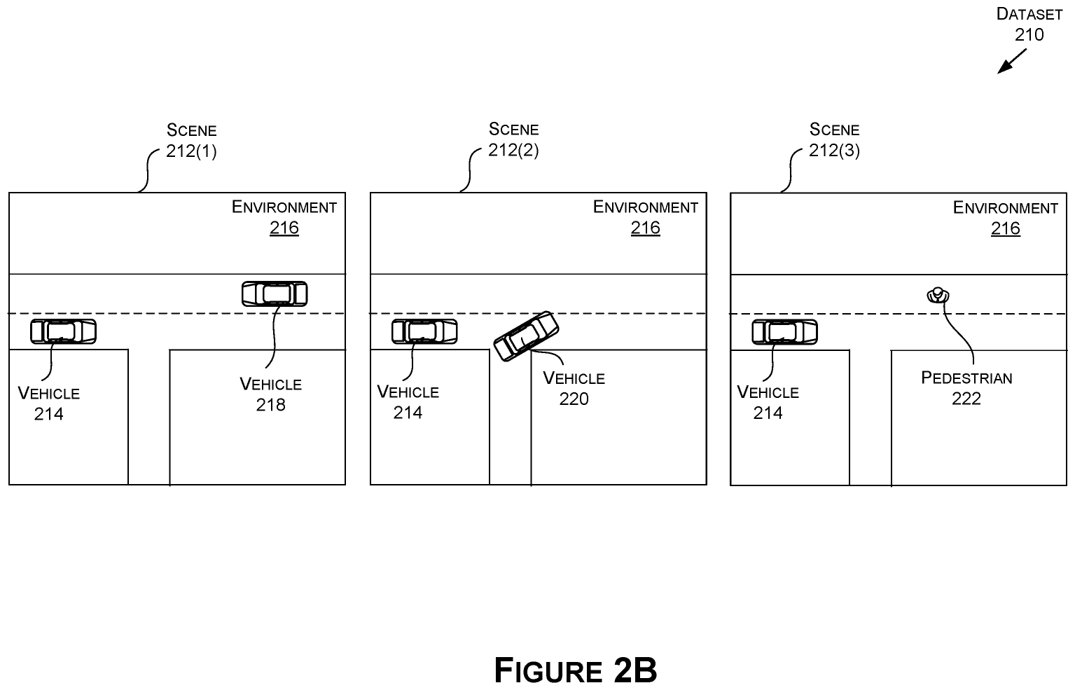

For instance, FIG. 2A illustrates a first example of the simulation component 110 performing simulations in order to generate a dataset 202 (which may represent, and/or include, a dataset 114), in accordance with some embodiments of the present disclosure. As shown, the dataset 202 may include a number of scenes 204(1)-(3) (also referred to singularly as “scene 204” or in plural as “scenes 204”), where each scene 204 is associated with a specific time instance. For instance, the first scene 204(1) may be associated with a first time instance where a first object 206(1) (e.g., a ball) is dropped from a location within an environment 208. Additionally, the second scene 204(2) may then be associated with a second time instance where the first object 206(1) contacts a second object 206(2) also located within the environment 208. Finally, the third scene 204(3) may be associated with a third time instance where the first object 206(1) comes to a resting position within the environment 208.

Additionally, FIG. 2B illustrates a second example of the simulation component 110 performing a simulation in order to generate a dataset 210 (which may represent, and/or include, a dataset 114), in accordance with some embodiments of the present disclosure. As shown, the dataset 210 may again include a number of scenes 212(1)-(3) (also referred to singularly as “scene 212” or in plural as “scenes 212”), where each scene 212 is associated with a different simulation result. For instance, the first scene 212(1) may be associated with a vehicle 214 navigating in an environment 216, where another vehicle 218 is navigating towards the vehicle 214 in an opposite lane. Additionally, the second scene 212(2) may be associated with the vehicle 214 again navigating in the environment 216, but where another vehicle 220 pulls in front of the vehicle 214. Furthermore, the third scene 212(2) may be associated with the vehicle 214 again navigating in the environment 216, but where a pedestrian 222 is crossing the road. In some examples, the dataset 210 may be used to train one or more systems (e.g., a perception system, a location system, a navigation system, etc.) associated with vehicles.

Referring back to the example of FIG. 1A, the process 100 may include the simulation component 110 using a sampling component 116 that processes at least the parameter file(s) 104 in order to sample values associated with the parameters for the simulation. For example, and for a simulation, the sampling component 116 may use the parameter file(s) 104 to determine a first parameter associated with the simulation. The sampling component 116 may then use sampling to determine a first value associated with the first parameter. As described herein, the first value may include a set value and/or the first value may be selected from a distribution associated with the first parameter. The sampling component 116 may then use the parameter file(s) 104 to determine a second parameter associated with the simulation. The sampling component 116 may then use sampling to determine a second value associated with the second parameter. As described herein, the second value may include a set value and/or the second value may be selected from a distribution associated with the second parameter. The sampling component 116 may then continue to perform these processes for one or more additional parameters represented by the parameter file(s) 104.

In some examples, a selected value may be associated with an asset (e.g., an element) from the asset list(s) 106. Additionally, the asset may be associated with an object model that is stored by the asset server(s) 108. As such, the simulation component 110 may retrieve the asset data 112 (e.g., a file) associated with the object model from the asset server(s) 108. This way, the simulation component 110 may use the object model when generating the simulation.

The process 100 may then include the simulation component 110 using a generation component 118 to perform the simulations (e.g., perform a generation associated with the simulations). For instance, to perform the simulations, the generation component 118 may use the parameters and/or the values for the parameters as determined by the sampling component 116, where the parameters and/or the values may be represented by 120. Additionally, to perform the simulations, generation component 118 may use the assets represented by the asset data 112. The generation component 118 may then use any technique to generate simulations using the parameters, the values, and the assets.

The process 100 may then include a capture component 122 capturing data, such as simulated scenes (e.g., images), simulated videos, simulated text, simulated systems, and/or any other type of simulated data associated with the simulations generated by the generation component 118. For a first example, if the generation component 118 generates simulations associated with an object dropping, then the capture component 122 may capture one or more scenes depicting the object from at least a time that the object starts to fall to a time that the object finally rests (e.g., the scenes 204 from the example of FIG. 2A). For a second example, if the generation component 118 generates simulations associated with a vehicle navigating, then the capture component 122 may capture one or more scenes depicting objects (e.g., vehicles, pedestrians, traffic signals) within an environment for which the vehicle is navigating over a period of time (e.g., the scenes 212 from the example of FIG. 2B). In any example, the capture component 122 may output the dataset(s) 114 representing the captured data from the simulations.

The process 100 may include the simulation component 110 (and/or another system and/or component) generating one or more generations log 124 associated with the simulations. As described herein, the generation log(s) 124 may later be used to again perform the simulations in order to regenerate the dataset(s) 114. For example, a generation log 124 may represent at least the parameters used by the simulation component 110, the values associated with the parameters, the assets retrieved, final values resulting from the stochastic processes of the simulation component 110 (e.g., (e.g., stochastic values derived from the simulation processes, such as values representing the final poses of objects), and/or any other information associated with the simulations. In some examples, at least some the parameters are written to the generation log 124 in the same order as the parameters that were used (e.g., sampled) by the simulation component 110 when generating the dataset(s) 114. For example, a first parameter sampled and/or a first value associated with the first parameter may be written, followed by a second parameter sampled and/or a second value associated with the second parameter, followed by a third parameter sampled and/or a third value associated with the third parameter, and/or so forth.

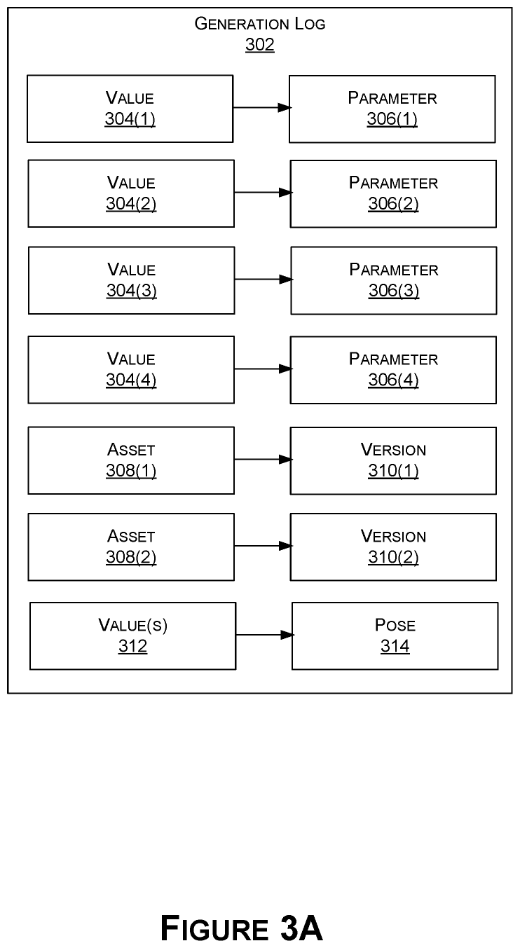

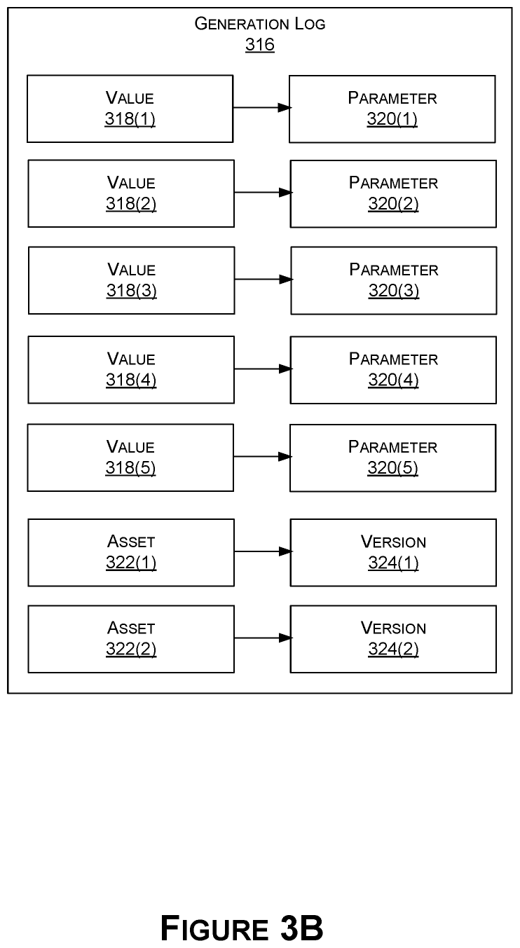

For instance, FIG. 3A illustrates a first example of a generation log 302 (which may represent, and/or include, a generation log 124) associated with a simulation, such as a simulation that generated the third scene 204(3) from the example of FIG. 2A, in accordance with some embodiments of the present disclosure. As shown, the generation log 302 may associate values 304(1)-(4) with parameters 306(1)-(4) used to generate the third scene 204(3). For instance, the first parameter 306(1) may be associated with a type of the first object 206(1), the second parameter 306(2) may be associated with a type of the second object 206(2), the third parameter 306(3) may be associated with lighting, and the fourth parameter 306(4) may be associated with camera configurations. As such, at least the first value 304(1) may be associated with a ball and the second value 304(2) may be associated with a pyramid. As described herein, in some examples, the order associated with the values 304(1)-(4) and/or the parameters 306(1)-(4) may be based on an order for which the parameters 306(1)-(4) were sampled during the simulation. For example, to generate the third scene 204(3), the first parameter 306(1) may have been sampled, followed by the second parameter 306(2), followed by the third parameter 306(3), and finally followed by the fourth parameter 306(4).

Additionally, the generation log 302 may further include assets 308(1)-(2) used to generate the third scene 204(3) as well as version numbers 310(1)-(2) associated with the assets 308(1)-(2). For example, the first asset 308(1) may be associated with the first object 206(1) and the version number 310(1) may indicate the version of the first object 206(1). Additionally, the second asset 308(2) may be associated with the second object 206(2) and the version number 310(2) may indicate the version of the second object 206(2). Furthermore, the generation log 302 may include one or more values 312 associated with a final pose 314 of at least the first object 206(1). As described herein, the value(s) may include stochastic values that are generated by the simulation component 102 when performing the simulation. For example, the value(s) 312 may indicate the location (e.g., the x-coordinate location, the y-coordinate location, and the z-coordinate location) and the pose (e.g., the roll, the pitch, and the yaw) associated with the first object 206(1) in the third scene 204(3), where the location and/or the pose is random since the first object 206(1) falls.

FIG. 3B illustrates a second example of a generation log 316 (which may represent, and/or include, a generation log 124) associated with a simulation, such as a simulation that generated the third scene 212(3) from the example of FIG. 2B, in accordance with some embodiments of the present disclosure. As shown, the generation log 316 may associate values 318(1)-(5) with parameters 320(1)-(5) used to generate the third scene 212(3). For instance, the first parameter 320(1) may be associated with a number of objects, the second parameter 320(2) may be associated with a type of object for the vehicle 214, the third parameter 320(3) may be associated with a type of object for the pedestrian 222, the fourth parameter 320(4) may be associated with lighting, and the fifth parameter 320(5) may be associated with the layout of the roads. As such, the first value 318(1) may be associated with two objects, the second value 318(2) may be associated with a vehicle, the third value 318(3) may be associated with a pedestrian, the fourth value 318(4) may be associated with daytime, and the fifth value 318(5) may be associated with an intersection. Additionally, as described herein, in some examples, the order associated with the values 318(1)-(5) and/or the parameters 320(1)-(5) may be based on an order for which the parameters 320(1)-(5) were sampled during the simulation. For example, to generate the third scene 212(3), the first parameter 320(1) may have been sampled, followed by the second parameter 320(2), followed by the third parameter 320(3), followed by the fourth parameter 320(4), and finally followed by the fifth parameter 320(5)

Additionally, the generation log 316 may further include assets 322(1)-(2) used to generate the third scene 212(3) as well as version numbers 324(1)-(2) associated with the assets 322(1)-(2). For example, the first asset 322(1) may be associated with the vehicle 214 and the version number 324(1) may indicate the version of the vehicle 214. Additionally, the second asset 322(1) may be associated with the pedestrian 222 and the version number 324(2) may indicate the version of the pedestrian 222.

While the examples of FIG. 3A-3B illustrate generating the generation logs 302 and 316 associated with the scenes 204(3) and 212(3), respectively, in other examples, one or more similar generation logs may be generated for the first scene 204(1), the second scene 204(2), the first scene 212(1), and/or the second scene 212(2). Additionally, in some examples, the generation log 302 and/or the generation log 316 may include information for additional parameters and/or assets associated with the third scene 204(3) and/or the third scene 212(3), respectively.

Referring back to the example of FIG. 1A, the process 100 may include associating at least a portion of the generation log(s) 124 with the dataset(s) 114. In some examples, the process 100 may include associating each of the generation log(s) 124 with the dataset(s) 114. In some examples, the process 100 may include associating portions of the generation log(s) 124 with portions of the dataset(s) 114. For example, if a generation log 124 is generated for a scene of the dataset(s) 114, then the generation log 124 may be associated with that scene. As described herein, the generation log(s) 124 may then be used to regenerate the dataset(s) 114.

For instance, FIG. 1B illustrates an example data flow diagram for a process 126 of regenerating the dataset(s) 114 using the generation log(s) 124 associated with the simulation(s), in accordance with some embodiments of the present disclosure. As described herein, in some examples, the generation log(s) 124 may be used to regenerate one or more datasets 128 that are substantially similar to the original dataset(s) 114 generated during the initial simulation(s). In such examples, to regenerate the dataset(s) 114, the simulation component 110 may receive, as input, the generation log(s) 124 and the asset data 112 representing the asset(s) used to generate the dataset(s) 114. In some examples, if the regeneration is associated with a portion of the dataset(s) 114, such as a scene, then the simulation component 110 may receive the generation log(s) 124 associated with the scene as well as the asset data 112 representing the asset(s) used to generate the scene. Additionally, when regenerating the dataset(s) 114, the simulation component 110 may not receive one or more parameter files 104 and/or one or more asset lists 106.

For instance, to regenerate the dataset(s) 112, the generation component 118 may use the parameter(s) and/or the value(s) of the parameter(s) as indicated by the generation log(s) 124 to again perform the simulation(s). As described herein, in order to perform the regeneration similar to the original generation, the generation component 118 may read the parameter(s) and/or the value(s) for the parameter(s) according to the order in the generation log(s) 124, where the order matches the original order from the original simulation(s). For example, and referring to the example of FIG. 3A, the generation component 118 may read the first value 304(1) for the first parameter 306(1), followed by the second value 304(2) for the second parameter 306(2), followed by the third value 304(3) for the third parameter 306(3), and finally followed by the fourth value 304(4) for the fourth parameter 306(4). Additionally, the generation component 118 may retrieve the asset data 112 representing the asset(s). For example, the simulation component 110 may retrieve the version number 310(1) of the first asset 308(1) and the version number 310(2) of the second asset 308(2). Furthermore, in some examples, the generation component 118 may use one or more final poses of one or more objects. For example, the generation component 118 may use the value(s) 312 of the pose 314 to determine the final pose of the first asset 308(1).

The process 126 may then include the capture component 122 capturing data, such as simulated scenes (e.g., images), simulated videos, simulated text, simulated systems, and/or any other type of simulated data associated with the simulation(s) generated by the simulation component 110. The capture component 122 may then output the dataset(s) 128 representing the captured data. As described herein, in examples where the simulation component 110 is configured to regenerate the dataset(s) 114 using the original generation log(s) 124, the dataset(s) 128 may substantially match the dataset(s) 114.

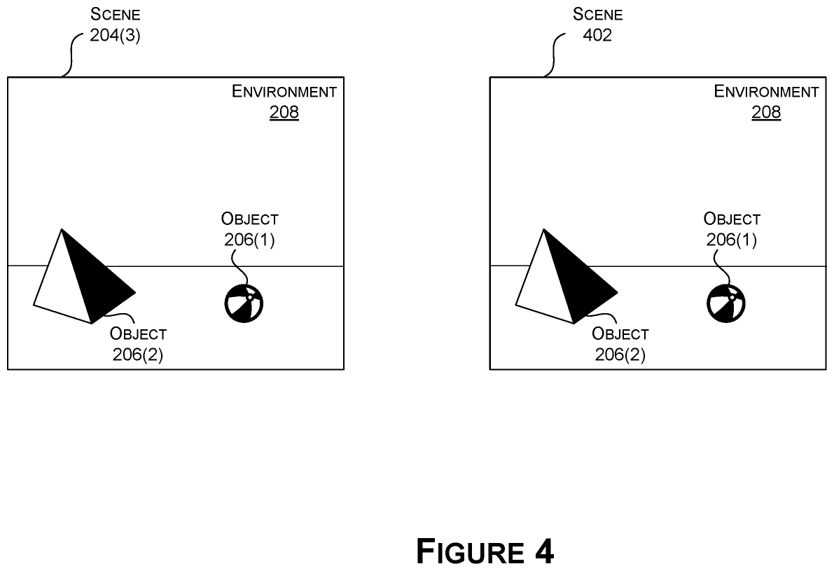

For instance, FIG. 4 illustrates an example of a dataset that is regenerated to be substantially similar to a previously generated dataset, in accordance with some embodiments of the present disclosure. As shown, by performing the process 126 of FIG. 1B, the simulation component 110 may generate a new dataset that includes at least a new scene 402 that is substantially similar to the third scene 204(3). For example, both the scene 402 and the third scene 204(3) include the same objects 206(1)-(2) located within the environment 208. Additionally, both the scene 402 and the third scene 204(3) include the first object 206(1) at substantially the same ending pose (e.g., using stochastic values). In some examples, the simulation component 110 may perform similar processes to also regenerate at least one of the scenes 204(1)-(2) and/or at least one of the scenes 212(1)-(3).

Referring back to the example of FIG. 1B, the process 126 may include the simulation component 110 (and/or another system and/or component) generating one or more generations logs 130 associated with the simulation(s). As described herein, the generation log(s) 130 may later be used to again perform the simulation(s) in order to regenerate the dataset(s) 114 and/or the dataset(s) 128. For example, a generation log 130 may represent at least the parameters used by the simulation component 110, the values associated with the parameters, the assets retrieved, final values resulting from the stochastic processes of the simulation component 110 (e.g., values representing the final poses of objects), and/or any other information. In some examples, at least some the parameters are written to the generation log(s) 130 in a same order as the parameters that were used (e.g., sampled) by the simulation component 110 when generating the dataset(s) 128. For example, a first parameter sampled and/or a first value associated with the first parameter may be written, followed by a second parameter sampled and/or a second value associated with the second parameter, followed by a third parameter sampled and/or a third value associated with the third parameter, and/or so forth. Additionally, since the process 126 is associated with generating the dataset(s) 128 to be substantially similar to the dataset(s) 112, the generation log(s) 130 may be substantially similar to the generation log(s) 124.

FIG. 1C illustrates an example data flow diagram for a first process 132 of regenerating the dataset(s) 114 using one or more modifications and/or enhancements, in accordance with some embodiments of the present disclosure. For instance, and as described herein, in some examples, to modify and/or enhance the original simulation(s), one or more users and/or systems may update the generation log(s) 124. For example, and as illustrated, an update component 134 may update one or more parameters from the generation log(s) 124, update one or more values from the generation log(s) 124, remove one or more parameters from the generation log(s) 124, add one or more parameters to the generation log(s) 124, update one or more assets from the generation log(s) 124, update one or more version numbers from the generation log(s), remove one or more assets from the generation log(s) 124, and/or add one or more assets to the generation log(s) 124 in order to generate one or more updated generation logs 136. In some examples, the update component 134 performs at least a portion of the updating based at least on receiving one or more inputs from one or more users. In some examples, the updating component 134 automatically performs at least a portion of the updating, such as by using one or more scripts, applications, and/or the like executed by the update component 134.

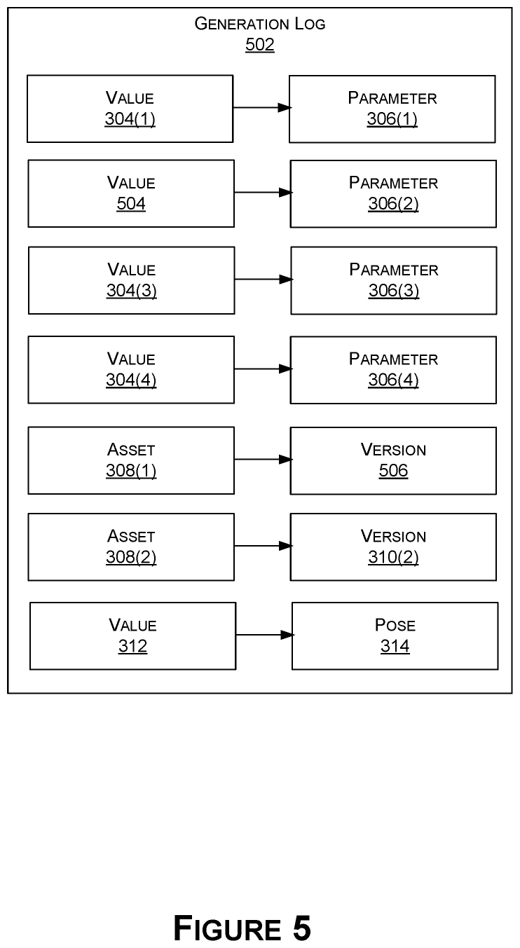

For instance, FIG. 5 illustrates an example of updating the generation log 302 associated with a simulation in order to generate an updated generation log 502, in accordance with some embodiments of the present disclosure. As shown by the example of FIG. 5, the update component 134 may update at least the second value 304(2) associated with the second parameter 306(2) to include a value 504 and update the version number 310(1) associated with the first asset 308(1) to include a new version number 506. However, in other examples, the update component 134 may further remove one or more parameters, add one or more parameters, update the value 312 associated with the final pose 314, and/or perform any other update.

Referring back to the example of FIG. 1C, to regenerate the dataset(s) 112 with the modification(s) and/or enhancement(s), the generation component 118 may use the parameter(s) and/or the value(s) of the parameter(s) as indicated by the generation log(s) 136 to again perform the simulation(s). As described herein, in order to perform the regeneration similar to the original generation, the generation component 118 may read the parameter(s) and/or the value(s) for the parameter(s) according to the order in the generation log(s) 136, where the order at least partially matches the original order from the original simulation(s). For example, and referring to the example of FIG. 5, the generation component 118 may read the first value 304(1) for the first parameter 306(1), followed by the value 504 for the second parameter 306(2), followed by the third value 304(3) for the third parameter 306(3), and finally followed by the fourth value 304(4) for the fourth parameter 306(4).

Additionally, the generation component 118 may retrieve asset data 138 representing one or more assets, where the asset(s) may change and/or be modified based at least on the generation log(s) 136. For example, the simulation component 110 may retrieve the new version 506 of the first asset 308(1) and the version number 310(2) of the second asset 308(2). Furthermore, in some examples, the generation component 118 may use one or more final poses of one or more objects. For example, the generation component 118 may use the value(s) 312 of the pose 314 to determine the final pose of the first asset 308(1).

The process 132 may then include the capture component 122 capturing data, such as simulated scenes (e.g., images), simulated videos, simulated text, simulated systems, and/or any other type of simulated data associated with the simulation(s) generated by the simulation component 110. The capture component 112 may then output one or more datasets 140 representing the captured data. As described herein, in examples where the simulation component 110 is configured to regenerate the dataset(s) 114 with the modification(s) and/or the enhancement(s), the dataset(s) 140 may still be similar to the dataset(s) 114, but with the included modification(s) and/or enhancement(s).

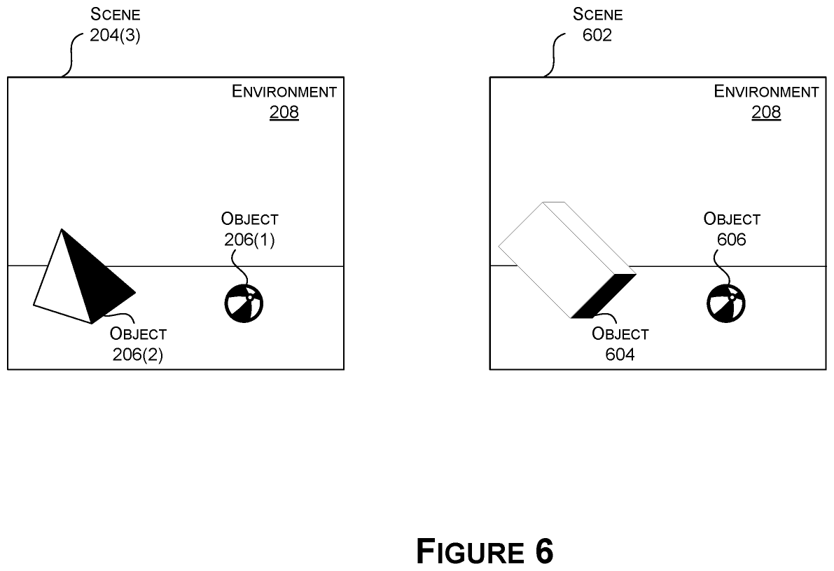

For instance, FIG. 6 illustrates an example of a modified dataset that is regenerated to be similar to a previously generated dataset, in accordance with some embodiments of the present disclosure. As shown, by performing the process 132 of FIG. 1C, the simulation component 110 may generate a new dataset that includes at least a new scene 602 that is related to the third scene 204(3), but with modifications. For example, the scene 602 includes a new object 604 that is a modified version of the second object 206(2). In some examples, this modification may be based on the new value 504 for the second parameter 306(2). Additionally, the scene 602 includes a new object 606 that is an updated version of the first object 206(1). In some examples, this modification may be based on the new version 506 of the first asset 308(1). Furthermore, both the scene 602 and the third scene 204(3) include the object 606 and the first object 206(1) as including a substantially similar pose. In some examples, the simulation component 110 may perform similar processes to also regenerate at least one of the scenes 204(1)-(2) and/or at least one of the scenes 212(1)-(3) with one or more modifications and/or one or more enhancements.

Referring back to the example of FIG. 1C, the process 132 may include the simulation component 110 (and/or another system and/or component) generating one or more generations logs 142 associated with the simulation(s). As described herein, the generation log(s) 142 may later be used to again perform the simulation(s) in order to regenerate the dataset(s) 140. For example, a generation log 142 may represent at least the parameters used by the simulation component 110, the values associated with the parameters, the assets retrieved, final values resulting from the stochastic processes of the simulation component 110 (e.g., values representing the final poses of objects), and/or any other information. In some examples, at least some the parameters are written to the generation log(s) 142 in a same order as the parameters that were used (e.g., sampled) by the simulation component 110 when generating the dataset(s) 140. For example, a first parameter sampled and/or a first value associated with the first parameter may be written, followed by a second parameter sampled and/or a second value associated with the second parameter, followed by a third parameter sampled and/or a third value associated with the third parameter, and/or so forth.

FIG. 1D illustrates an example data flow diagram for a second process 144 of regenerating the dataset(s) 114 using one or more modifications and/or enhancements, in accordance with some embodiments of the present disclosure. As shown by the example of FIG. 1D, the process 144 may include the parsing component 102 receiving one or more new parameter files 146 and/or one or more new asset lists 148 associated with the regeneration of the dataset(s) 114. For instance, the parameter file(s) 146 may include one or more new parameters, one or more new values for the new parameter(s), one or more modified values for the parameter(s) associated with the generation log(s) 124, and/or the like associated with the regeneration. The process 144 may then include the parsing component 102 sending the parameter file(s) 146 and/or the asset list(s) 148 to the simulation component 110.

As such, the input associated with the regeneration may include the generation log(s) 124, the parameter file(s) 146, the asset list(s) 148, and/or asset data 138 representing one or more assets associated with the simulation(s). For example, the generation component 118 may use the parameter(s) and/or the value(s) of the parameter(s) from the generation log(s) 124 and/or the parameter(s) and/or the value(s) of the parameter(s) from the parameter file(s) 146 (which may be represented by 152) to again perform the simulation(s), but with the modification(s) and/or the enhancement(s). As described herein, in order to perform the regeneration similar to the original generation, the generation component 118 may read the parameter(s) and/or the value(s) for the parameter(s) according to the order in the generation log(s) 124 and/or the parameter file(s) 146, where the order at least partially matches the original order from the original simulation(s). The generation component 118 may also retrieve the asset data 150 representing the asset(s) needed to perform the simulation(s).

The process 144 may then include the capture component 122 capturing data, such as simulated scenes (e.g., images), simulated videos, simulated text, simulated systems, and/or any other type of simulated data associated with the simulation(s) generated by the simulation component 110. The capture component 112 may then output one or more datasets 154 representing the captured data. As described herein, in examples where the simulation component 110 is configured to regenerate the dataset(s) 114 with the modification(s) and/or the enhancement(s), the dataset(s) 154 may still be similar to the dataset(s) 114, but with the included modification(s) and/or enhancement(s).

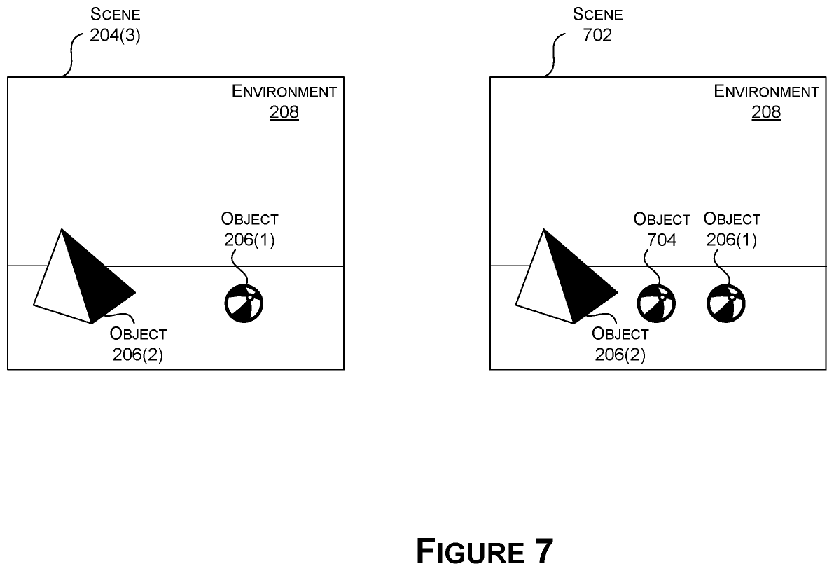

For instance, FIG. 7 illustrates an example of a modified dataset that is regenerated to be similar to a previously generated dataset using one or more new parameter files, in accordance with some embodiments of the present disclosure. As shown, by performing the process 144 of FIG. 1D, the simulation component 110 may generate a new dataset that includes at least a new scene 702 that is similar to the third scene 204(3), but with enhancements. For example, both the scene 702 and the third scene 204(3) include the same objects 206(1)-(2) located within the environment 208. Additionally, both the scene 702 and the third scene 204(3) include the first object 206(1) at substantially the same ending pose. Furthermore, the scene 702 may include a new object 704 located at a new pose within the environment 208, where the new object 704 is based on the new parameter file(s). In some examples, the simulation component 110 may perform similar processes to also regenerate at least one of the scenes 204(1)-(2) and/or at least one of the scenes 212(1)-(3).

Referring back to the example of FIG. 1D, the process 144 may include the simulation component 110 (and/or another system and/or component) generating one or more generations logs 156 associated with the simulation(s). As described herein, the generation log(s) 156 may later be used to again perform the simulation(s) in order to regenerate the dataset(s) 154. For example, a generation log 156 may represent at least the parameters used by the simulation component 110, the values associated with the parameters, the assets retrieved, final values resulting from the stochastic processes of the simulation component 110 (e.g., values representing the final poses of objects), and/or any other information. In some examples, at least some the parameters are written to the generation log(s) 156 in the same order as the parameters that were used (e.g., sampled) by the simulation component 110 when generating the dataset(s) 154. For example, a first parameter sampled and/or a first value associated with the first parameter may be written, followed by a second parameter sampled and/or a second value associated with the second parameter, followed by a third parameter sampled and/or a third value associated with the third parameter, and/or so forth.

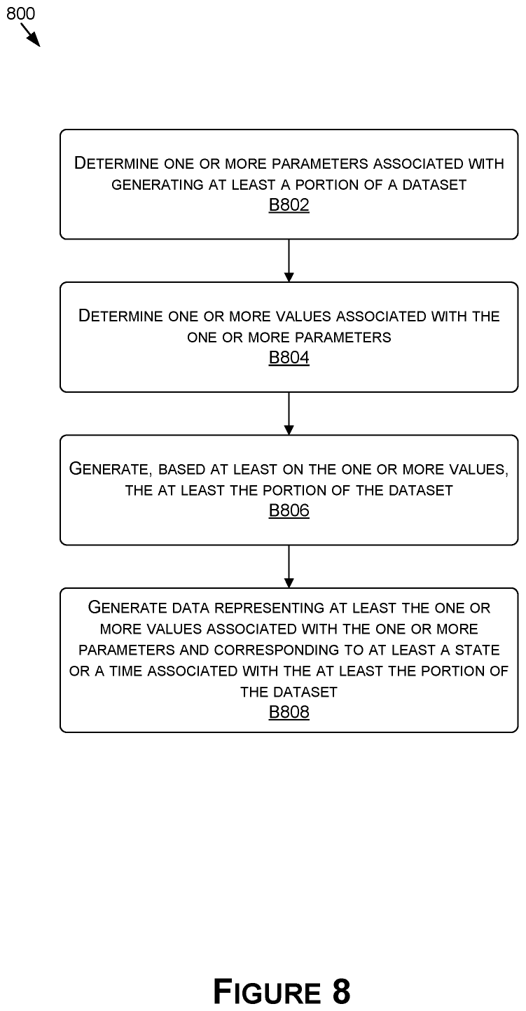

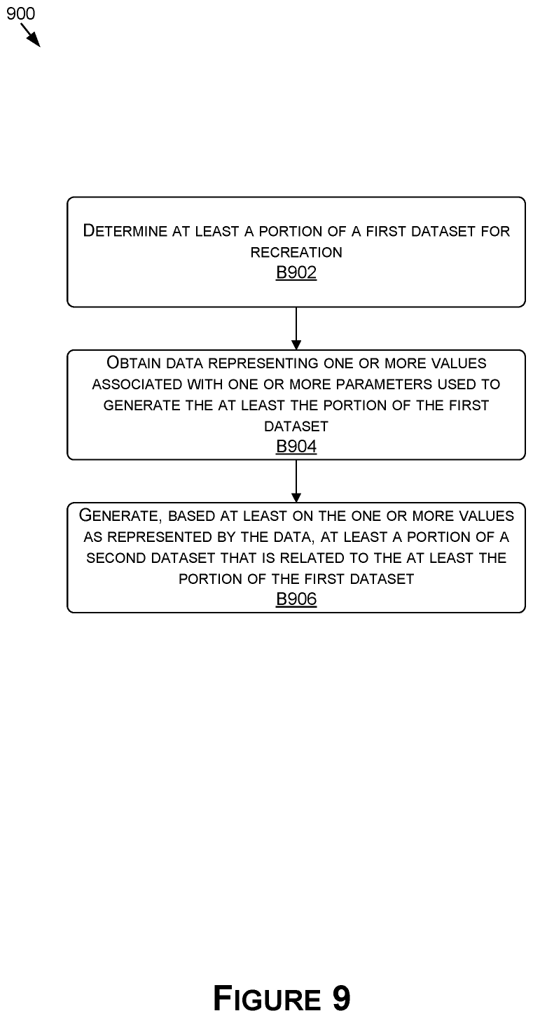

Now referring to FIGS. 8 and 9, each block of methos 800 and 900, described herein, comprises a computing process that may be performed using any combination of hardware, firmware, and/or software. For instance, various functions may be carried out by a processor executing instructions stored in memory. The methods 800 and 900 may also be embodied as computer-usable instructions stored on computer storage media. The methods 800 and 900 may be provided by a standalone application, a service or hosted service (standalone or in combination with another hosted service), or a plug-in to another product, to name a few. In addition, the method 800 and 900 are described, by way of example, with respect to FIGS. 1A-1D. However, these methods 800 and 900 may additionally or alternatively be executed by any one system, or any combination of systems, including, but not limited to, those described herein.

FIG. 8 is a flow diagram showing a method 800 for generating log data for regenerating a dataset associated with a simulation, in accordance with some embodiments of the present disclosure. The method 800, at block B802, may include determining one or more parameters associated with generating at least a portion of a dataset. For instance, the simulation component 110 may determine the parameter(s) associated with generating the at least the portion of the dataset(s) 114. As described herein, in some examples, the simulation component 110 may determine the parameter(s) based at least on the parameter(s) file(s) 104. For example, the parameter file(s) 104 may represent the parameter(s) for performing the simulation. Additionally, as described herein, a parameter may include an object parameter (e.g., a type, a count, a texture, a model, a pose, a color, etc.), a camera parameters (e.g., a configuration, a lens parameter, a resolution parameter, etc.), a lighting parameter, a scenario parameter, an output parameter (e.g., a dataset name, a dataset size, a sequence timestep, a dataset type, etc.), and/or any other type of parameter associated with simulations.

The method 800, at block B804, may include determining one or more values associated with the one or more parameters. For instance, the simulation component 110 may determine the value(s) associated with the parameter(s). As described herein, in some examples, the simulation component 110 may determine the value(s) based at least on the parameter file(s) 104. For example, the parameter file(s) 104 may include key value pairs, such as pairs that associate the parameter(s) with the value(s). In some examples, the simulation component 110 determines the value(s) by sampling the parameter(s) in an order. For example, the simulation component 110 may sample a first parameter to determine a first value for the first parameter, followed by sampling a second parameter to determine a second value for the second parameter, followed by sampling a third parameter to determine a third value for the third parameter, and/or so forth.

The method 800, at block B806, may include generating, based at least on the one or more values, the at least the portion of the dataset. For instance, the simulation component 110 may generate the at least the portion of the dataset(s) 114 based at least on the value(s) of the parameter(s). As described herein, the at least the portion of the dataset(s) 114 may include one or more simulated scenes (e.g., images), one or more simulated videos, simulated text, one or more simulated systems, and/or any other type of simulated data associated with the simulation. Additionally, in some examples, the simulation component 110 may generate the at least the portion of the dataset(s) 114 using the asset data 112 representing one or more assets associated with the simulation.

The method 800, at block B808, may include generating data representing at least the one or more values associated with the one or more parameters and corresponding to at least a state or a time associated with the at least a portion of the simulated dataset. For instance, the simulation component 110 may generate the data representing the generation log(s) 124, where the generation log(s) 124 includes at least the value(s) for the parameter(s). In some examples, the generation log(s) 124 may include the value(s) of the parameter(s) in a same order for which the parameter(s) was sampled during the simulation. Additionally, as described herein, in some examples, the generation log(s) 124 may further indicate the asset(s) used to generate the at least the portion of the dataset(s) 114, the version(s) associated with the asset(s), one or more values associated with one or more poses associated with one or more objects, and/or one or more stochastic values associated with the simulation (e.g., one or more values indicating a final pose of an object).

Additionally, in some examples, the generation log(s) 124 may correspond to a state and/or a time associated with the at least the portion of the dataset. For instance, the generation log(s) 124 may be associated with one or more instances (e.g., scenes) of the dataset, where the one or more instances are associated with a time and/or state of the simulation. For example, one or more scenes (e.g., each scene) of the dataset may correspond to a respective time and/or state. As such, and as described herein, the generation log(s) 124 may be associated with such a time and/or state.

FIG. 9 is a flow diagram showing a method 900 for regenerating a dataset using log data associated with a simulation, in accordance with some embodiments of the present disclosure. The method 900, at block B902, may include determining at least a portion of a first dataset 114 for recreation. For instance, the simulation component 110 may determine the at least the portion of the first dataset for recreation. As described herein, the at least the portion of the first dataset 114 may include one or more simulated scenes (e.g., images), one or more simulated videos, simulated text, one or more simulated systems, and/or any other type of simulated data associated with the simulation. In some examples, the simulation component 110 determines the at least the portion of the first dataset 114 based at least on user input.

The method 900, at block B904, may include obtaining data representing one or more values associated with one or more parameters used to generate the at least the portion of the first dataset. For instance, the simulation component 110 may receive the data representing the value(s) associated with the parameter(s) used to generate the at least the portion of the first dataset 114. As described herein, the data may represent the generation log(s) 124 associated with the first dataset 114 and/or the updated generation log(s) 142 modified by one or more users and/or systems. In some examples, the simulation component 110 may further receive the new parameter file(s) 146 and/or the new asset list(s) 148 associated with the regeneration, such as when the regeneration includes a modification and/or an enhancement.

The method 900, at block B906, may include generating, based at least on the one or more values as represented by the data, at least a portion of a second dataset that is related to the at least the portion of the first dataset. For instance, the simulation component 110 may perform the regeneration using at least the data representing the generation log(s) 124 and/or the generation log(s) 142. In some examples, the simulation component 110 may perform the regeneration by at least sampling the value(s) of the parameter(s) based at least on an order associated with the generation log(s) 124 and/or the generation log(s) 142. Additionally, in some examples, the simulation component 110 may perform the regeneration using the asset data 112, the parameter file(s) 146, the asset list(s) 148, and/or the asset data 150.

### Example Autonomous Vehicle

FIG. 10A is an illustration of an example autonomous vehicle 1000, in accordance with some embodiments of the present disclosure. The autonomous vehicle 1000 (alternatively referred to herein as the “vehicle 1000”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3-Level 5 of the autonomous driving levels. The vehicle 1000 may be capable of functionality in accordance with one or more of Level 1-Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to enable the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. 10C) and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to enable autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LIDAR sensor(s) 1064, inertial measurement unit (IMU) sensor(s) 1066 (e.g., accelerometer(s), gyroscope(s), magnetic compass(es), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMI) display 1034, an audible annunciator, a loudspeaker, and/or via other components of the vehicle 1000. The outputs may include information such as vehicle velocity, speed, time, map data (e.g., the High Definition (“HD”) map 1022 of FIG. 10C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HD map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation enabling any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LIDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1012 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to enable communication with peripherals, audio codecs, power management, and/or other devices. The SoC(s) 1004 may be used to process data from cameras (e.g., connected over Gigabit Multimedia Serial Link and Ethernet), sensors (e.g., LIDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to enable wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated by the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1060 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060 m (front) or 80 m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5 m, 4 m). The ultrasonic sensor(s) 1062 may operate at functional safety levels of ASIL B.

The vehicle 1000 may include LIDAR sensor(s) 1064. The LIDAR sensor(s) 1064 may be used for object and pedestrian detection, emergency braking, collision avoidance, and/or other functions. The LIDAR sensor(s) 1064 may be functional safety level ASIL B. In some examples, the vehicle 1000 may include multiple LIDAR sensors 1064 (e.g., two, four, six, etc.) that may use Ethernet (e.g., to provide data to a Gigabit Ethernet switch).

In some examples, the LIDAR sensor(s) 1064 may be capable of providing a list of objects and their distances for a 360-degree field of view. Commercially available LIDAR sensor(s) 1064 may have an advertised range of approximately 1000 m, with an accuracy of 2 cm-3 cm, and with support for a 1000 Mbps Ethernet connection, for example. In some examples, one or more non-protruding LIDAR sensors 1064 may be used. In such examples, the LIDAR sensor(s) 1064 may be implemented as a small device that may be embedded into the front, rear, sides, and/or corners of the vehicle 1000. The LIDAR sensor(s) 1064, in such examples, may provide up to a 120-degree horizontal and 35-degree vertical field-of-view, with a 200 m range even for low-reflectivity objects. Front-mounted LIDAR sensor(s) 1064 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1000. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may enable the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LIDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1000), while the I2V communication concept provides information about traffic further ahead. CACC systems may include either or both I2V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may run a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be fed into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. In other words, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084(H) (collectively referred to herein as GPUs 1084), PCIe switches 1082(A)-1082(H) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may run its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: determining one or more parameters associated with at least a portion of a simulated dataset; determining one or more values associated with the one or more parameters; generating, using one or more simulation systems and based at least on one or more values, the at least the portion of the simulated dataset; and based at least on the generating the at least the portion of the simulated dataset, generating data representing at least the one or more values associated with the one or more parameters and corresponding to at least a state or a time associated with the at least a portion of the simulated dataset.

B: The method of paragraph A, further comprising: determining one or more poses associated with one or more objects represented by the at least the portion of the simulated dataset, wherein the data further represents the one or more pose values for the one or poses.

C: The method of paragraph A or paragraph B, wherein: the determining of the one or more values associated with the one or more parameters comprises at least sampling a first parameter of the one or more parameters to determine a first value of the one or more values followed by sampling a second parameter of the one or more parameters to determine a second value of the one or more values; and the data further represents an order that includes the first value associated with the first parameter followed by the second value associated with the second parameter.

D: The method of any one of paragraphs A-C, further comprising: determining one or more assets associated with the one or more parameters, wherein the data further represents at least one of the one or more assets or one or more versions associated with the one or more assets.

E: The method of any one of paragraphs A-D, wherein the one or more values comprise at least one of: one or more random values associated with one or more first parameters of the one or more parameters; or one or more set values associated with one or more second parameters of the one or more parameters.

F: The method of any one of paragraphs A-E, wherein the at least the portion of the simulated dataset is a first portion of the simulated dataset, and wherein the method further comprises: generating, based at least on one or more second values associated with one or more second parameters, a second portion of the simulated dataset, wherein the data further represents the one or more second values associated with the one or more second parameters.

G: The method of any one of paragraphs A-F, further comprising: determining one or more stochastic values resulting from the generating the at least the portion of the simulated dataset, wherein the data further represents the one or more stochastic values.

H: The method of any one of paragraphs A-G, further comprising regenerating the at least the portion of the simulated dataset based at least on the one or more values associated with the one or more parameters as represented by the data.

I: The method of any one of paragraphs A-H, further comprising: generating updated data by modifying at least one value of the one or more values that is associated with at least one parameter of the one or more parameters as represented by the data; and generating based at least on the updated data, at least a portion of a second simulated dataset that is related to the at least the portion of the simulated dataset.

J: The method of any one of paragraphs A-I, further comprising: generating parameter data representing at least one or more second parameters and one or more second values associated with the one or more second parameters; and generating based at least on the data and the parameter data, at least a portion of a second simulated dataset that is related to the at least the portion of the simulated dataset.

K: A system comprising: one or more processing units to: determine at least a portion of a first simulated dataset for recreation; obtain data representing one or more values associated with one or more parameters used to generate the at least the portion of the first simulated dataset; and generate, based at least on the one or more values associated with the one or more parameters, at least a portion of a second simulated dataset that is similar to the at least the portion of the first simulated dataset.

L: The system of paragraph K, wherein: the data represents an order that includes at least a first parameter of the one or more parameters followed by a second parameter of the one or more parameters; and the generation of the at least the portion of the second simulated dataset comprises at least sampling, based at least on the order represented by the data, the first parameter to determine a first value of the one or more values followed by sampling the second parameter to determine a second value of the one or more values in order to generate the at least the portion of the second simulated dataset.

M: The system of paragraph K or paragraph L, wherein: the data further represents one or more poses associated with one or more objects as represented by the at least the portion of the first simulated dataset; and the generation of the at least the portion the second simulation dataset is further based at least on the one or more pose values for the one or more poses.

N: The system of any one of paragraphs K-M, wherein the one or more processing units are further to: generate updated data by modifying at least one value of the one or more values that is associated with at least one parameter of the one or more parameters as represented by the data, wherein the generation of the at least the portion of the second simulation dataset is based at least on the updated data.

O: The system of any one of paragraphs K-N, wherein the one or more processing units are further to: generate parameter data representing one or more second values associated with one or more second parameters, wherein the generation of the at least the portion of the second simulation dataset is further based at least on the one or more second values associated with the one or more second parameters as represented by the parameter data.

P: The system of any one of paragraphs K-O, wherein: the data further represents one or more assets associated with the one or more parameters; and the generation of the at least the portion of the second simulation dataset is further based at least on the one or more assets as represented by the data.

Q: The system of any one of paragraphs K-P, wherein the one or more processing units are further to: determine the one or more parameters associated with the first simulated dataset; determine the one or more values associated with the one or more parameters; generate, based at least on one or more values, the first simulated dataset; and based at least on the generation of the first simulated dataset, generate the data representing at least the one or more values associated with the one or more parameters.

R: The system of any one of paragraphs K-Q, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system implemented using a robot; a system implementing one or more large language models; a system implementing one or more large language models (LLMs); a system for performing conversational AI operations; a system for generating synthetic data; a system for performing AI operations; a system incorporating one or more virtual machines (VMs); a system implemented at least partially in a data center; or a system implemented at least partially using cloud computing resources.

S: A processor comprising: one or more processing units to generate log data associated with a generation of a simulated scene, where the log data represents at least one or more parameters sampled for generating the simulated scene along with one or more values associated with the one or more parameters.

T: The processor of paragraph S, wherein the processor is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system implemented using an edge device; a system implemented using a robot; a system implementing one or more large language models; a system implementing one or more large language models (LLMs); a system for performing conversational AI operations; a system for generating synthetic data; a system for performing AI operations; a system incorporating one or more virtual machines (VMs); a system implemented at least partially in a data center; or a system implemented at least partially using cloud computing resources.

What is claimed is:

1. A method comprising:
determining one or more parameters associated with at least a portion of a simulated dataset;
determining one or more values associated with the one or more parameters;
generating, using one or more simulation systems and based at least on one or more values, the at least the portion of the simulated dataset; and
based at least on the generating the at least the portion of the simulated dataset, generating data representing at least the one or more values associated with the one or more parameters and corresponding to at least a state or a time associated with the at least a portion of the simulated dataset.

2. The method of claim 1, further comprising:
determining one or more poses associated with one or more objects represented by the at least the portion of the simulated dataset,
wherein the data further represents the one or more pose values for the one or poses.

3. The method of claim 1, wherein:
the determining of the one or more values associated with the one or more parameters comprises at least sampling a first parameter of the one or more parameters to determine a first value of the one or more values followed by sampling a second parameter of the one or more parameters to determine a second value of the one or more values; and
the data further represents an order that includes the first value associated with the first parameter followed by the second value associated with the second parameter.

4. The method of claim 1, further comprising:
determining one or more assets associated with the one or more parameters,
wherein the data further represents at least one of the one or more assets or one or more versions associated with the one or more assets.

5. The method of claim 1, wherein the one or more values comprise at least one of:
one or more random values associated with one or more first parameters of the one or more parameters; or
one or more set values associated with one or more second parameters of the one or more parameters.

6. The method of claim 1, wherein the at least the portion of the simulated dataset is a first portion of the simulated dataset, and wherein the method further comprises:
generating, based at least on one or more second values associated with one or more second parameters, a second portion of the simulated dataset,
wherein the data further represents the one or more second values associated with the one or more second parameters.

7. The method of claim 1, further comprising:
determining one or more stochastic values resulting from the generating the at least the portion of the simulated dataset,
wherein the data further represents the one or more stochastic values.

8. The method of claim 1, further comprising regenerating the at least the portion of the simulated dataset based at least on the one or more values associated with the one or more parameters as represented by the data.

9. The method of claim 1, further comprising:
generating updated data by modifying at least one value of the one or more values that is associated with at least one parameter of the one or more parameters as represented by the data; and
generating based at least on the updated data, at least a portion of a second simulated dataset that is related to the at least the portion of the simulated dataset.

10. The method of claim 1, further comprising:
generating parameter data representing at least one or more second parameters and one or more second values associated with the one or more second parameters; and
generating based at least on the data and the parameter data, at least a portion of a second simulated dataset that is related to the at least the portion of the simulated dataset.

11. A system comprising:
one or more processing units to:
determine at least a portion of a first simulated dataset for recreation;
obtain data representing one or more values associated with one or more parameters used to generate the at least the portion of the first simulated dataset; and
generate, based at least on the one or more values associated with the one or more parameters, at least a portion of a second simulated dataset that is similar to the at least the portion of the first simulated dataset.

12. The system of claim 11, wherein:
the data represents an order that includes at least a first parameter of the one or more parameters followed by a second parameter of the one or more parameters; and
the generation of the at least the portion of the second simulated dataset comprises at least sampling, based at least on the order represented by the data, the first parameter to determine a first value of the one or more values followed by sampling the second parameter to determine a second value of the one or more values in order to generate the at least the portion of the second simulated dataset.

13. The system of claim 11, wherein:
the data further represents one or more poses associated with one or more objects as represented by the at least the portion of the first simulated dataset; and
the generation of the at least the portion the second simulation dataset is further based at least on the one or more pose values for the one or more poses.

14. The system of claim 11, wherein the one or more processing units are further to:
generate updated data by modifying at least one value of the one or more values that is associated with at least one parameter of the one or more parameters as represented by the data,
wherein the generation of the at least the portion of the second simulation dataset is based at least on the updated data.

15. The system of claim 11, wherein the one or more processing units are further to:
generate parameter data representing one or more second values associated with one or more second parameters,
wherein the generation of the at least the portion of the second simulation dataset is further based at least on the one or more second values associated with the one or more second parameters as represented by the parameter data.

16. The system of claim 11, wherein:
the data further represents one or more assets associated with the one or more parameters; and
the generation of the at least the portion of the second simulation dataset is further based at least on the one or more assets as represented by the data.

17. The system of claim 11, wherein the one or more processing units are further to:
determine the one or more parameters associated with the first simulated dataset;
determine the one or more values associated with the one or more parameters;
generate, based at least on one or more values, the first simulated dataset; and
based at least on the generation of the first simulated dataset, generate the data representing at least the one or more values associated with the one or more parameters.

18. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system implementing one or more large language models;
a system implementing one or more large language models (LLMs);
a system for performing conversational AI operations;
a system for generating synthetic data;
a system for performing AI operations;
a system incorporating one or more virtual machines (VMs);
a system implemented at least partially in a data center; or
a system implemented at least partially using cloud computing resources.

19. A processor comprising:
one or more processing units to generate log data associated with a generation of a simulated scene, where the log data represents at least one or more parameters sampled for generating the simulated scene along with one or more values associated with the one or more parameters.

20. The processor of claim 19, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system implementing one or more large language models;
a system implementing one or more large language models (LLMs);
a system for performing conversational AI operations;
a system for generating synthetic data;
a system for performing AI operations;
a system incorporating one or more virtual machines (VMs);
a system implemented at least partially in a data center; or
a system implemented at least partially using cloud computing resources.
